(19) United States
(12) Patent Application Publication
(10) Pub. No.: US 2026/0301048 A1
(43) Pub. Date: Oct. 1, 2026

(54) METHOD AND SYSTEM FOR RECOMMENDING A FURNITURE ITEM

(71) Applicant: Fulhaus Inc., Montreal (CA)

(72) Inventors: Dheeraj Reddy Peddireddy, Montreal (CA); Uneku Idumajogu, Brossard (CA); Andria Santos Pragelas, Ouest-Bolton (CA)

(21) Appl. No.: 19/700,553

(22) Filed: Jun. 8, 2026

Related U.S. Application Data
(63) Continuation-in-part of application No. 18/382,274, filed on Oct. 20, 2023, now Pat. No. 12,657,869.
(60) Provisional application No. 63/380,271, filed on Oct. 20, 2022.

(51) Int. Cl. G06Q 30/0601

(52) U.S. Cl. CPC G06Q 30/0631

(57) ABSTRACT

A method for recommending a furniture item to a user, the method being executed by a processing device, the method including: receiving a design request indicative of at least one desired furniture item from a user device; generating a design brief based on the design request; accessing a database comprising product records each associated with a respective furniture item, each one of the product records comprising vendor metadata about the respective furniture item and semantic attribute values associated with the respective furniture item; and identifying at least one given furniture item based on the product records and the design brief; and outputting an indication of the at least one given furniture item.

### CROSS REFERENCE TO RELATED APPLICATIONS

The subject application is a continuation-in-part of U.S. patent application Ser. No. 18/382,274 filed Oct. 20, 2023 and issued as U.S. Pat. No. 12,657,869, which claims the benefit of U.S. Provisional Patent Application No. 63/380,271 filed Oct. 20, 2022, the contents of each application incorporated herein by reference in their entirety.

### FIELD

The present technology pertains to the field of recommendation methods and systems, and more particularly to methods and systems for recommending a furniture item.

### BACKGROUND

More and more short-term rental (STR) property owners look for providing unique and elevated experience to their rental clients to increase their listing competitivity in this market, and the profit. However, in order to deliver this experience, the property owners usually rely on interior design services to help them purchase high quality furniture and install the furniture as fast as possible so that the rental properties can generate profits as soon as possible.

However, traditional interior design services usually have a long turn over period, due to the complexity of design nature, i.e., communicate the vision, modify the design, select and purchase products and the shipment. Such a long project timeline cannot usually satisfy the needs of STR operators.

Therefore, there is a need for a method and systems for recommending furniture items.

### SUMMARY

According to a first broad aspect, there is provided a system for recommending a furniture item to a user, the system comprising: a processor; and a non-transitory readable storage medium operatively connected to the processor, the non-transitory readable storage medium comprising computer-readable instructions stored thereon, the processor, upon execution of the instructions, being configured for: receiving a design request indicative of at least one desired furniture item from a user device; generating a design brief based on the design request; accessing a database comprising product records each associated with a respective furniture item, each one of the product records comprising vendor metadata about the respective furniture item and semantic attribute values associated with the respective furniture item; identifying at least one given furniture item based on the product records and the design brief; and outputting an indication of the at least one given furniture item.

In some embodiments, the generation of the design brief comprises: generating a prompt instructing an artificial intelligence model to create the design brief; transmitting the prompt and the design request to the artificial intelligence model; and receiving the design brief from the artificial intelligence model.

In some embodiments, the processor is further configured for allowing an interaction between the artificial intelligence model and the user via the user device to construct the design brief.

In some embodiments, the processor is further configured for receiving an inspiration image and transmitting the inspiration image to the artificial intelligence model along with the design request and the prompt, the design brief being generated further based on the inspiration image.

In some embodiments, the identification of the at least one given furniture item comprises: generating a prompt instructing an artificial intelligence model to construct a query comprising semantic attribute filters; transmitting the prompt and the design brief to the artificial intelligence model; providing the artificial intelligence model with an access to the database; and receiving the at least one given furniture item from the artificial intelligence model, the artificial intelligence model identifying the at least one given furniture item based on the prompt, the design brief and the product records stored in the database.

In some embodiments, each one of the product record further comprises a reference vector representation for the respective furniture item, the method further comprising: receiving an inspiration image; generating a vector representation of the inspiration image; and transmitting the vector representation of the inspiration image to the artificial intelligence model along with prompt and the design brief, the at least one given furniture item being identified further based on the vector representation of the inspiration image.

In some embodiments, said receiving the at least one given furniture item from the artificial intelligence model comprises receiving a plurality of given furniture items, the method further comprises selecting a given one of plurality of given furniture items based on the vector representation of the inspiration image.

In some embodiments, said outputting the indication of the at least one given furniture item comprises: generating a visual representation of the at least one given furniture item within a space; and outputting the visual representation.

In some embodiments, the processor is further configured for receiving a space image, said generating the visual representation being performed based on the space image.

According to another broad aspect, there is provided a system for creating a database of furniture items, the system comprising: a processor; and a non-transitory readable storage medium operatively connected to the processor, the non-transitory readable storage medium comprising computer-readable instructions stored thereon, the processor, upon execution of the instructions, being configured for: receiving, for each one of a plurality of furniture items, vendor metadata and at least one vendor image; generating a vector representation of the at least one vendor image for each one of a plurality of furniture items; for each one of a plurality of furniture items, determining a value for each one of predefined semantic attributes based at least on the vendor metadata and the at least one vendor image, the value being selected amongst predefined possible values; and storing, for each one of a plurality of furniture items, the value of each one of predefined semantic attributes and the vector representation of the at least one vendor image.

In some embodiments, the processor is further configured for generating a cutout image from the at least one vendor image, said generating the vector representation of the at least one vendor image comprising generating a vector representation of the cutout image and said storing the vector representation of the at least one vendor image comprising storing the vector representation of the cutout image.

According to a further broad aspect, there is provided a method for recommending a furniture item to a user, the method being executed by a processing device, the method comprising: receiving a design request indicative of at least one desired furniture item from a user device; generating a design brief based on the design request; accessing a database comprising product records each associated with a respective furniture item, each one of the product records comprising vendor metadata about the respective furniture item and semantic attribute values associated with the respective furniture item; identifying at least one given furniture item based on the product records and the design brief; and outputting an indication of the at least one given furniture item.

In some embodiments, said generating a design brief comprises: generating a prompt instructing an artificial intelligence model to create the design brief; transmitting the prompt and the design request to the artificial intelligence model; and receiving the design brief from the artificial intelligence model.

In some embodiments, the method further comprises allowing an interaction between the artificial intelligence model and the user via the user device to construct the design brief.

In some embodiments, the method further comprises receiving an inspiration image and transmitting the inspiration image to the artificial intelligence model along with the design request and the prompt, the design brief being generated further based on the inspiration image.

In some embodiments, said identifying the at least one given furniture item comprises: generating a prompt instructing an artificial intelligence model to construct a query comprising semantic attribute filters; transmitting the prompt and the design brief to the artificial intelligence model; providing the artificial intelligence model with an access to the database; and receiving the at least one given furniture item from the artificial intelligence model, the artificial intelligence model identifying the at least one given furniture item based on the prompt, the design brief and the product records stored in the database.

In some embodiments, each one of the product record further comprises a reference vector representation for the respective furniture item, the method further comprising: receiving an inspiration image; generating a vector representation of the inspiration image; and transmitting the vector representation of the inspiration image to the artificial intelligence model along with prompt and the design brief, the at least one given furniture item being identified further based on the vector representation of the inspiration image.

In some embodiments, said receiving the at least one given furniture item from the artificial intelligence model comprises receiving a plurality of given furniture items, the method further comprises selecting a given one of plurality of given furniture items based on the vector representation of the inspiration image.

In some embodiments, said outputting the indication of the at least one given furniture item comprises: generating a visual representation of the at least one given furniture item within a space; and outputting the visual representation.

In some embodiments, the method further comprises receiving a space image, said generating the visual representation being performed based on the space image.

According to still another broad aspect, there is provided a computer program product comprising a computer readable memory storing computer executable instructions thereon that when executed by at least one processor perform the steps of the method for recommending a furniture item to a user.

According to still a further broad aspect, there is provided a method for creating a database of furniture items, the method being executed by a processing device, the method comprising: receiving, for each one of a plurality of furniture items, vendor metadata and at least one vendor image; generating a vector representation of the at least one vendor image for each one of a plurality of furniture items; for each one of a plurality of furniture items, determining a value for each one of predefined semantic attributes based at least on the vendor metadata and the at least one vendor image, the value being selected amongst predefined possible values; and storing, for each one of a plurality of furniture items, the value of each one of predefined semantic attributes and vector representation of the at least one vendor image.

In some embodiments, the method further comprises generating a cutout image from the at least one vendor image, said generating the vector representation of the at least one vendor image comprising generating a vector representation of the cutout image and said storing the vector representation of the at least one vendor image comprising storing the vector representation of the cutout image.

According to still another broad aspect, there is provided a computer program product comprising a computer readable memory storing computer executable instructions thereon that when executed by at least one processor perform the steps of the method for creating a database of furniture items.

Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first,” “second,” “third,” etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a schematic diagram of an electronic device in accordance with one or more non-limiting embodiments of the present technology.

FIG. 2 illustrates a schematic diagram of a communication system in accordance with one or more non-limiting embodiments of the present technology.

FIG. 3 is a flow chart illustrating a method for selecting a furniture item based on a reference image, in accordance with a first embodiment.

FIG. 4 is a flow chart illustrating a method for selecting a furniture item based on a reference image, in accordance with a second embodiment.

FIG. 5 is a flow chart illustrating a method for creating a database of furniture items, in accordance with an embodiment.

FIG. 6 is a flow chart illustrating a method for recommending a furniture item, in accordance with an embodiment.

FIG. 7 is a flow chart illustrating a method for generating a visual representation of a recommended furniture item, in accordance with an embodiment.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Electronic Device

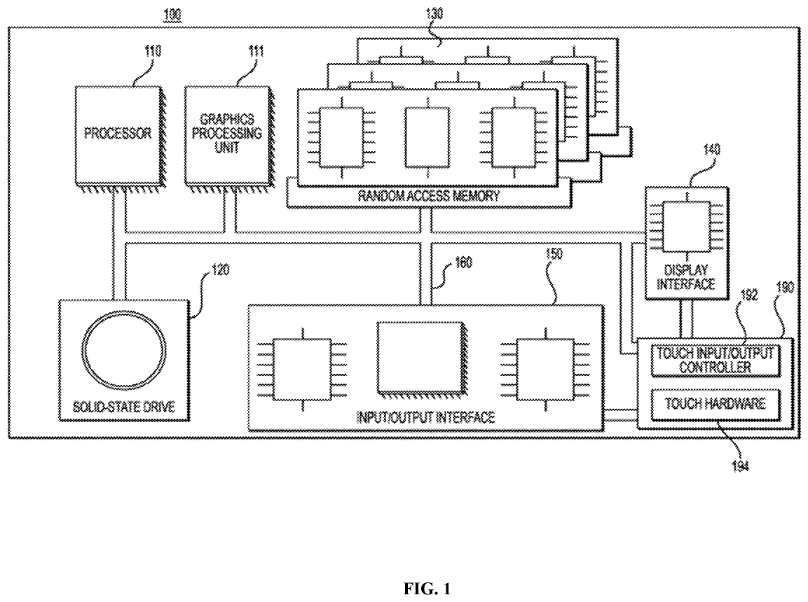

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111 for training an embedding model to perform link prediction in a knowledge hypergraph. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

### System

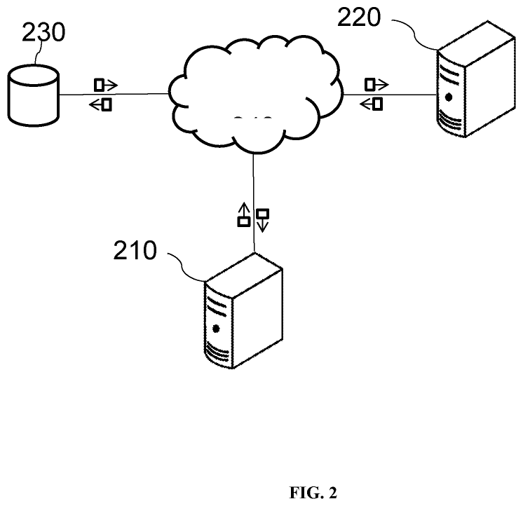

Referring to FIG. 2, there is shown a schematic diagram of a system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a client device 210 associated with a user, a server 220, and a database 230 communicatively coupled over a communications network 240.

### Client Device

The system 200 comprises a client device 210. The client device 210 is associated with the user. As such, the client device 210 can sometimes be referred to as a “electronic device”, “end user device” or “client electronic device”. It should be noted that the fact that the client device 210 is associated with the user does not need to suggest or imply any mode of operation—such as a need to log in, a need to be registered, or the like.

The client device 210 comprises one or more components of the electronic device 100 such as one or more single or multi-core processors collectively represented by processor 110, the graphics processing unit (GPU) 111, the solid-state drive 120, the random-access memory 130, the display interface 140, and the input/output interface 150.

In one or more embodiments, the user may use the client device 210 to query a recommendation of furniture item(s) based on a reference image and to receive the recommendation. The recommendation for the furniture item(s) may be for example executed by the server 220.

### Server

The server 220 is configured to generate a recommendation of furniture item(s) based on a reference image.

How the server 220 is configured to do so will be explained in more detail herein below.

It will be appreciated that the server 220 can be implemented as a conventional computer server and may comprise at least some of the features of the electronic device 100 shown in FIG. 1. In a non-limiting example of one or more embodiments of the present technology, the server 220 is implemented as a server running an operating system (OS). Needless to say that the server 220 may be implemented in any suitable hardware and/or software and/or firmware or a combination thereof. In the disclosed non-limiting embodiment of present technology, the server 220 is a single server. In one or more alternative non-limiting embodiments of the present technology, the functionality of the server 220 may be distributed and may be implemented via multiple servers (not shown).

The implementation of the server 220 is well known to the person skilled in the art. However, the server 220 comprises a communication interface (not shown) configured to communicate with various entities (such as the database 230, for example and other devices potentially coupled to the communication network 240) via the communication network 240. The server 220 further comprises at least one computer processor (e.g., the processor 110 of the electronic device 100) operationally connected with the communication interface and structured and configured to execute various processes to be described herein.

In some non-limiting embodiments, the server 220 is configured for:
(i) receiving a reference image and a room type from the client device 210;
(ii) determining a main type of furniture items based on the room type;
(iii) accessing a database 230 comprising a plurality of main reference furniture items each belonging to the main type of furniture items;
(iv) selecting a given one of the main reference furniture items based on the reference image; and
(v) outputting an identification of the given one of the main reference furniture items.

In some non-limiting embodiments, the server 220 is configured for:
(i) receiving a reference image and a room type from the client device 210;
(ii) determining a main type of furniture items based on the room type;
(iii) accessing a database 230 comprising a respective vector representation for main reference furniture items each belonging to the main type of furniture items;
(iv) generating a vector representation of the reference image;
(v) selecting a given main reference furniture item by comparing the vector representation of the reference image and the respective vector representations of the reference furniture items; and
(vi) outputting an identification of the given one of the main reference furniture items.

In some non-limiting embodiments, the server 220 is configured for:
(i) receiving a design request indicative of at least one desired furniture item from a user device;
(ii) determining a main type of furniture items based on the room type;
(iii) receiving a design request indicative of at least one desired furniture item from a user device;
(iv) generating a design brief based on the design request;
(v) accessing a database comprising product records each associated with a respective furniture item, each one of the product records comprising vendor metadata about the respective furniture item and semantic attribute values associated with the respective furniture item; and
(vi) identifying at least one given furniture item based on the product records and the design brief; and
(vii) outputting an indication of the at least one given furniture item.

In some non-limiting embodiments, the server 220 is configured for:
(i) receiving, for each one of a plurality of furniture items, vendor metadata and at least one vendor image;
(ii) generating a vector representation of the at least one vendor image for each one of a plurality of furniture items;
(iii) for each one of a plurality of furniture items, determining a value for each one of predefined semantic attributes based at least on the vendor metadata and the at least one vendor image, the value being selected amongst predefined possible values; and
(iv) storing, for each one of a plurality of furniture items, the value of each one of predefined semantic attributes and vector representation of the at least one vendor image.

### Database

A database 230 is communicatively coupled to the server 220 and the client device 210 via the communications network 240 but, in one or more alternative implementations, the database 230 may be directly coupled to the server 220 without departing from the teachings of the present technology. Although the database 230 is illustrated schematically herein as a single entity, it will be appreciated that the database 230 may be configured in a distributed manner, for example, the database 230 may have different components, each component being configured for a particular kind of retrieval therefrom or storage therein.

The database 230 may be a structured collection of data, irrespective of its particular structure or the computer hardware on which data is stored, implemented or otherwise rendered available for use. The database 230 may reside on the same hardware as a processor that stores or makes use of the information stored in the database 230 or it may reside on separate hardware, such as on the server 220. The database 230 may receive data from the server 220 for storage thereof and may provide stored data to the server 220 for use thereof.

In some embodiments, the database 230 is configured to store inter alia an identification of main reference furniture items that each belong to a main type of furniture items. In an example in which a sofa represents the main type of furniture items, the database 230 may store different reference sofas. In another example in which a bed represents the main type of furniture items, the database 230 may store different reference beds. The database 230 further comprises at least one room type and an associated main type of furniture items.

In some embodiments, similar-looking main reference furniture items are regrouped together to enhance object recognition. For instance, categories like ‘Sofa,’ ‘Love seat,’ and ‘Sectional’ are intelligently consolidated into a single ‘Sofa’ category or main type of furniture. Such a strategic categorization not only improves the model's ability to differentiate between closely related items but also contributes to more accurate and relevant furniture recommendations.

In some embodiments, the identification of a main reference furniture item comprises a name, an ID code, a product code, a picture of the main reference furniture item, and/or the like.

In some embodiments, the identification of a main reference furniture item may further comprise a vector representation of the main reference furniture item, i.e., a vector representation of the features of the main reference item. For example, a vector representation may comprise at least one embedding or feature vector (such as a set of feature vectors) representing features of the main reference furniture item. In some embodiments, the vector representation is indicative of low-level features such as edges, color, gradient direction, etc. In some embodiments, a feature vector is a 4608-dimensional feature vector.

In some embodiments, the vector representation may further comprise, for each main reference furniture item, a respective color vector obtained by calculating color histograms.

In some embodiments, the vector representation may comprise a combined vector resulting from the combination or aggregation of a feature vector and a color vector.

In some embodiments, the database 230 also comprises, per type of rooms, secondary reference furniture items that belong to at least one secondary type of furniture items associated with a respective room type. For example, when the room type is a living room and the main type of furniture items is a sofa, the database 230 may comprise at least one secondary type of furniture items such as chair, carpet and floor lamp. In this case, the database 230 comprises a set of secondary reference furniture items for each secondary type of furniture items, e.g., a set of reference chairs, a set of reference carpets. a set of reference floor lamps and/or the like.

In some embodiments, a vector such as a feature vector, a color vector and/or a combined vector may be associated with each secondary reference furniture item contained in the database 230.

In some embodiments, the database 230 comprises different room types and for each room type, a set of main reference furniture items that belong to a respective main type of furniture items, and optionally at least of set of secondary reference furniture items that belong at least one respective secondary type of furniture items. For example, the types of rooms stored on the database 230 may be a bedroom and a living room. In this case, the database 230 comprises a first set of main reference furniture items for the bedroom, such as reference beds, and a second set of main reference furniture items for the living room, such as reference sofas. Optionally, the database 230 may at least one secondary type of furniture items for the bedroom. In this case, the database 230 comprises at least one set of secondary reference furniture items for the bedroom, such a set of reference nightstands, a set of reference carpets, a set of reference bedside lamps, etc. Similarly, the database 230 may comprise at least one secondary type of furniture items for the living room. In this case, the database 230 comprises at least one set of secondary reference furniture items for the living room, such a set of reference chairs, a set of reference floor lamps, a set of reference carpets, etc.

In some embodiments, the database 230 comprises a product record for each reference furniture item. A product record comprises inter alia: vendor metadata about the furniture item and semantic attribute values associated with the furniture item, a vendor image of the furniture item, a cutout image, and/or a vector representation.

The database 230 may store well-known file formats such as, but not limited to image file formats (e.g., .png, .jpeg), video file formats (e.g., .mp4, .mkv, etc.), archive file formats (e.g., .zip, .gz, .tar, .bzip2), document file formats (e.g., .docx, .pdf, .txt) or web file formats (e.g., .html).

### Communication Network

In one or more embodiments of the present technology, the communications network 240 is the Internet. In one or more alternative non-limiting embodiments, the communication network 240 may be implemented as any suitable local area network (LAN), wide area network (WAN), a private communication network or the like. It will be appreciated that implementations for the communication network 240 are for illustration purposes only. How a communication link 245 (not separately numbered) between the client device 210, the server 220, the database 230, and/or another electronic device (not shown) and the communications network 240 is implemented will depend inter alia on how each electronic device is implemented.

The communication network 240 may be used in order to transmit data packets amongst the client device 210, the server 220 and the database 230. For example, the communication network 240 may be used to transmit requests from the client device 210 to the server 220. In another example, the communication network 240 may be used to transmit a response to the request from the server 220 to the client device 210.

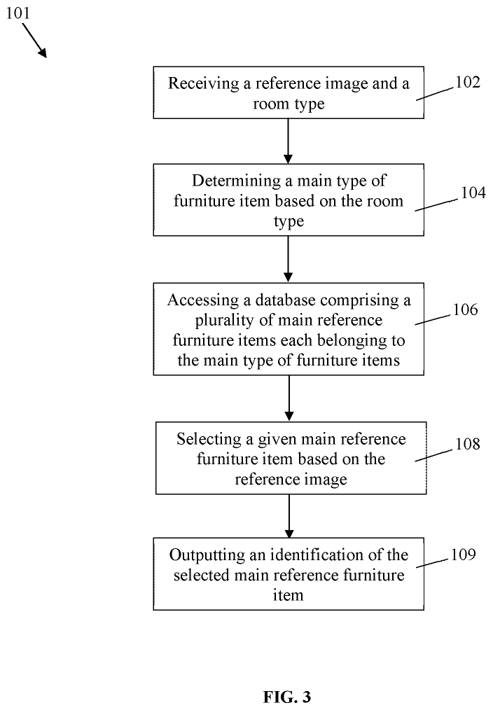

Having explained how the electronic device 100 and the communication system 200 are implemented in accordance with one or more non-limiting embodiments of the present technology, reference will now be made to FIG. 3, which illustrates a recommendation method 100 in accordance with one or more non-limiting embodiments of the present technology.

FIG. 3 illustrates one embodiment of a computer-implemented method 101 for selecting or recommending a furniture item based on a reference image. The method 101 may be executed by an electronic device such as server 220.

A furniture item should be understood as a furniture or a piece of furniture that is designed or used to support various human activities such as sitting, eating, storing items, working, and sleeping. A furniture item may be a seating furniture, a table, a storage furniture, a bed, etc. Examples of furniture items comprise chairs, stools, benches, couches, recliners, ottomans, dining tables, coffee tables, end tables, side tables, console tables, desks, beds, sofas, cabinets, chests of drawers, dressers, wardrobes, closets, bookcases, shelves, beds, mattresses, headboards, footboards, bunk beds, sofa beds, futons, lamps, and/or the like. A furniture item may also be a decorative or ornamental item or object such as a blanket, a rug, a frame, a painting, a carpet, a switch, a lamp, a light bulb, etc.

At step 102, a reference image and a room type or an indication of a room type are received. The reference image and the indication of a room type may be transmitted to the server 220 by a user from the client device 210 for example.

A reference image may be seen as a source of inspiration for selecting the furniture item. In some embodiments, the reference image may be an image of a furniture item, such as a picture or an illustration of a furniture item. In other embodiments, the reference image may be an image of a room or a part of room, in which at least one furniture item is present. In further embodiments, the reference image may be unrelated to furniture items or rooms. For example, the reference image may be an image of an object, an animal, a person, a scene, etc.

The room type is indicative of the type of room in which the furniture item to be selected is to be placed. For example, a type of room may be a bedroom, a kitchen, a dining room, a living room, an office, etc.

In some embodiments in which the reference image is an image of a room, a room part or a furniture item, the step 102 comprises receiving the reference image only and determining the room type based on the received reference image. In embodiments in which the reference image is an image of a room or part of a room, object recognition or detection or classification can be used to identify the type of the room contained in the reference image. In embodiments in which the reference image is an image of a furniture item, object recognition or detection or classification may be used to identify the furniture item contained in the reference image or the furniture type of the furniture item, and the room type is determined based on the identified furniture or furniture type. For example, a database, such as database 230, containing furniture items and/or furniture types each associated with a respective room type may be accessed to determine the room type associated with the received reference image. For example, when it is determined that the reference image is an image of a bed and the database associates a bed with a bedroom, it is then determined that the room type associated with the received reference image is a bedroom.

It should be understood that any adequate object recognition method may be used for determining the room type associated with a reference image. For example, Convolutional Neural Networks (CNN), Region-based Convolutional Neural Networks (R-CNN) and its variants such as Fast R-CNN or Faster R-CNN, You Only Look Once (YOLO), Single Shot Multibox Detector (SSD), RetinaNet, Mask R-CNN, Vision Transformers (ViTs), Residual Networks (ResNets), or the like may be used for recognizing an object within an image.

At step 104, a main type of furniture items is determined based on the received room type.

In some embodiments, the main type of furniture items is determined by accessing the database 230 and retrieving the main type of furniture items associated with the received room type.

At step 106, the database 230 is accessed in order to retrieve, identify or have access to the main reference furniture items that belong to the determined main type of furniture items for the received room type. For example, if the room type is a living room and the determined main type of furniture items associated with a living room may be a sofa, then access is provided to the reference sofas associated with the living room of the database 230.

At step 108, a given one of the main reference furniture items that belong to the determined main type of furniture items for the received room type is selected based on the reference image and an identification of the selected main reference furniture item is outputted at step 110. For example, the identification of the selected main reference furniture item may be stored in memory or sent to the client device 210. The identification of the selected main reference furniture item may be the name of the selected main reference furniture item, an identification code, a product number, etc. In another example, the identification of the selected main reference furniture item corresponds to an image of the selected main reference furniture item which is retrieved from the database 230 and provided for display on the client device 210.

In some embodiments, the method 101 further comprises a step of determining whether the reference image comprises a furniture item that belongs to the determined main type of furniture items. In one embodiment in which the reference image comprises such a furniture item, the step 108 comprises selecting the given main reference furniture item based only on the furniture item contained in the reference image. In another embodiment in which the reference image comprises such a furniture item, the selection of the main reference furniture item is performed based on the furniture item contained in the reference image and the reference image itself, at step 108. In still another embodiment in which the reference image comprises such a furniture item, the selection of the main reference furniture item is performed based on the furniture item contained in the reference image and the remaining of the reference image, i.e., the reference image from which the identified furniture item has been removed.

In some embodiments, the method 101 further comprises a step of determining at least one secondary reference furniture item. In this case, for each secondary type of furniture items stored in the database 230, a given secondary reference furniture item is selected amongst the secondary reference furniture items stored in the database 230 based on the received reference image and the selected main reference furniture object.

For example, when a reference sofa has been selected for a living room at step 108, a reference chair, a reference floor lamp and a reference carpet may be further selected from the database 230 based on the reference image and the selected reference sofa.

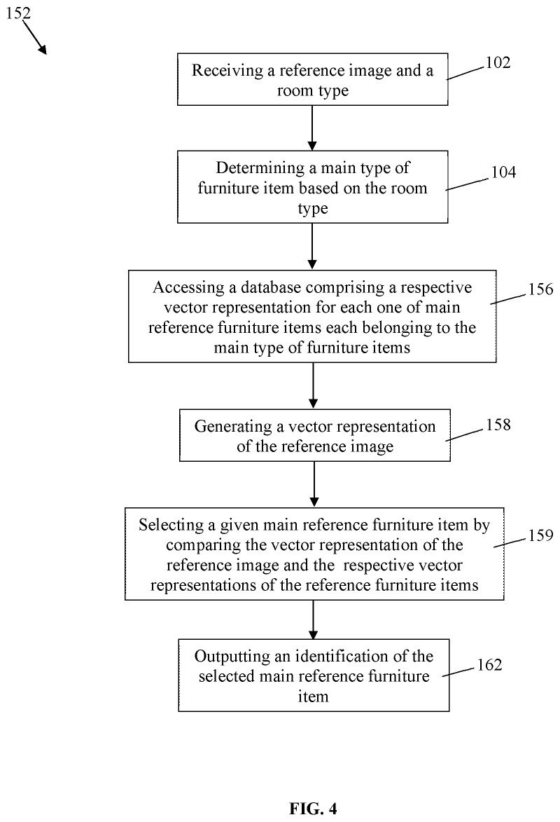

FIG. 4 illustrates another embodiment of a computer-implemented method 152 for selecting or recommending a furniture item based on a reference image. The method 152 may be executed by an electronic device such as server 220.

Similarly, to the method 101, the method 152 comprises the step 102 of receiving a reference image and a room type, and the step 104 of determining a main type of furniture items based on the received room type.

In this embodiment, the database 230 comprises an embedding or vector representation for each main reference furniture item contained in the database 230 and for each main type of furniture items. As described above, a vector representation may comprise at least one feature vector (such as a set of vectors) representing features of the main reference furniture item. The vector representation may also comprise a color vector. In a further example, the vector representation may comprise a combined vector obtained by combining together a feature vector and a color vector.

At step 156, the database 230 is accessed in order to retrieve, identify or have access to the vector representations of the main reference furniture items that belong to the determined main type of furniture items for the received room type. For example, if the room type is a living room and the determined main type of furniture items associated with a living room is a sofa, then access is provided to the vector representations of the reference sofas associated with the living room of the database 230.

At step 158, a vector representation of the reference image is generated. It should be understood that any adequate embedding method for generating a vector representation of an image may be used.

In some embodiment, the same embedding method is used for generating the vector representations of the main reference furniture items stored in the database 230 and the vector representation of the reference image.

In some embodiments, step 158 comprises generating at least one feature vector for the reference image. It should be understood that any adequate method for generating a feature vector of an image may be used. For example, a CNN, an autoencoder or the like may be used for generating the feature vector of an image.

In some embodiments, the same embedding method is used for generating the feature vectors of the main reference furniture items stored in the database 230 and the feature vector of the reference image.

In some embodiments, step 158 further comprises generating a color vector from the reference image and combining together the feature and color vectors generated for the reference image to obtain a combined vector.

At step 159, a given main reference furniture item is selected by comparing the vector representation of the reference image and the vector representations of the main reference furniture items, thereby obtaining a selected main reference furniture item.

In some embodiments, step 159 comprises comparing the feature vector generated for the reference image to the feature vectors of the main reference furniture items stored in the database 230.

In some embodiments, step 159 comprises comparing the combined vector generated for the reference image to the combined vectors of the main reference furniture items stored in the database 230.

In some embodiments, the selected main reference furniture item corresponds to the nearest neighbor of reference image, i.e., the vector representation of the selected main reference furniture item is the vector presentation of the main reference furniture items that is the nearest to the vector representation of the reference image.

In some embodiments, the selected main reference furniture item is determined by identifying the feature vector of the selected main reference furniture items that is the nearest to the feature vector of the reference image.

In some embodiments, the selected main reference furniture item is determined by identifying the combined vector of the selected main reference furniture items that is the nearest to the combined vector of the reference image.

At step 162, the identification of the selected main reference furniture item is outputted.

In some embodiments, the method 152 further comprises a step of determining whether the reference image comprises a furniture item that belongs to the determined main type of furniture items. In this case, object recognition may be used for identifying the furniture item that belongs to the determined main type of furniture items in the reference image. In some embodiment in which the reference image comprises such a furniture item, the step 159 comprises generating a vector representation of the item belonging to the main type of furniture items contained in the reference image and the step of selecting the given main reference furniture item is performed by comparing the vector representation of the reference image item to the vector representations of the main reference furniture items stored in the database 230. In other embodiments in which the reference image comprises such a furniture item, the step 159 comprises generating a vector representation of the item belonging to the main type of furniture items and contained in the reference image, and the step of selecting the given main reference furniture item is performed by combining together the vector representation of the reference image item and the vector representation of the reference image to obtain a merged vector representation, and comparing the merged vector representation to the vector representations of the main reference furniture items stored in the database 230. In still other embodiments in which the reference image comprises such a furniture item, the step 159 comprises generating a first vector representation of the item belonging to the main type of furniture items and contained in the reference image and a second vector representation for the remaining of the reference image, i.e., the reference image from which the identified furniture item has been removed, to obtain a merged vector representation, and comparing the merged vector representation to the vector representations of the main reference furniture items stored in the database 230.

In some embodiments, combining two vector representations is performed by adding the two vector representations using weight factors. In another embodiment, the combination of two vector representations comprises multiplying together two vector representations. In a further embodiment, the combination of two vector representations comprises aggregating together two vector representations. It should be understood that any adequate method for combining together two vector representations may be used.

In some embodiments, the method 152 further comprises generating the vector representation of each main reference furniture item and storing the generated vector representations into the database 230.

In some embodiments, the method 152 further comprises a step of identifying at least one secondary reference furniture item. In this case, the database 230 comprises at least one secondary type of furniture items associated with the type of room and a vector representation for each secondary reference furniture item. The method 152 further comprises generating a merged vector representation by combining the vector representation of the reference image and the vector representation of the vector representation of the selected main reference furniture item to obtain a combined vector representation. For example, the two vector representations may be added together using weight factors. In another example, the two vector representations may be aggregated together, as described above. For each secondary type of furniture items associated with the received room type, at least one secondary reference furniture item is selected by comparing the merged vector representation to the vector representations of the secondary reference furniture items stored in the database 230. In some embodiments, the selected secondary reference furniture item corresponds to the secondary reference furniture item of which the vector representation is the nearest neighbor to the combined vector representation. It should be understood that more than one secondary furniture item may be selected for each secondary type of furniture items. For example, the database 230 may store three secondary types of furniture items associated with a room type and two secondary reference furniture items may be selected for each one of the three secondary types of furniture items, e.g., when for a living room, the three secondary types are carpets, floor light and chair, two reference carpets, two reference floor lamps and two reference chairs are selected from the database 230.

While in the above description, a single main furniture item is selected at step 108 of method 101 and step 158 of method 152, it should be understood that more than one main reference furniture item may be selected. For example, when vector representations are used for the selection step, the first x number of nearest neighbors may be selected. In an embodiment in which more than one main reference furniture item is selected, at least one secondary reference furniture item may also be selected for each selected main reference furniture item.

In an embodiment in which the reference image is analyzed to determine whether it contains a furniture item, to identify the type of a furniture item contained in the reference image or to determine the type of a room represented in the reference image, it should be understood that any adequate method for detecting or recognizing objects within an image may be used. For example, the server 220 may be configured to execute methods such as a fast R-CNN method, a RetinaNet method, a Single shot detection (SSD) method, etc. In some embodiments, the server 220 is configured for executing a YOLO model. This object detection model calculates the different class probabilities as well as the bounding boxes in a single propagation through a convolutional neural network. In some embodiments, the YOLO model is trained on the Darknet Backend, which is trained on Imagenet dataset. In another embodiment, the YOLO model is trained on COCO dataset. The pre-trained model provides the category probabilities as well as the bounding box locations in an image.

In an embodiment in which spectral representations are used for selecting the main reference furniture object, any adequate feature extraction method for extracting high level convolutional features from an image and allowing for a vector representation of the extracted features may be used. For example, a convolutional neural network model may be used. In some embodiments, the server 220 may be configured for executing VGG19 which is a deep convolutional neural network model. In some embodiments, the VGG19 model is trained on more than million images from Imagenet. This pre-trained network can classify images into 1,000 different categories. In some embodiments, the reference image is resized to 100×100×3 before being passed into the VGG19 Deep CNN model to obtain a 4068-dimensional feature vector.

In an embodiment in which the main reference furniture item is selected by determining at least one closest neighbor, it should be understood that any adequate method for determining closest neighbors may be used. In some embodiments, the server 220 is configured for executing a K-nearest neighbors (KNN) method which is used for both regression and classification. By calculating the distance between the test data and all of the training points, KNN tries to predict the correct class for the test data. Then the K points that are closest to the test data are chosen. The KNN algorithm determines which classes of the “K” training data the test data will belong to, and the class with the highest probability is chosen. Similarity scores may be used in calculating the closest points in the dataset.

In the following, there is described methods and systems for creating a database, generating a recommendation for an interior design and generating a visual representation of an interior design.

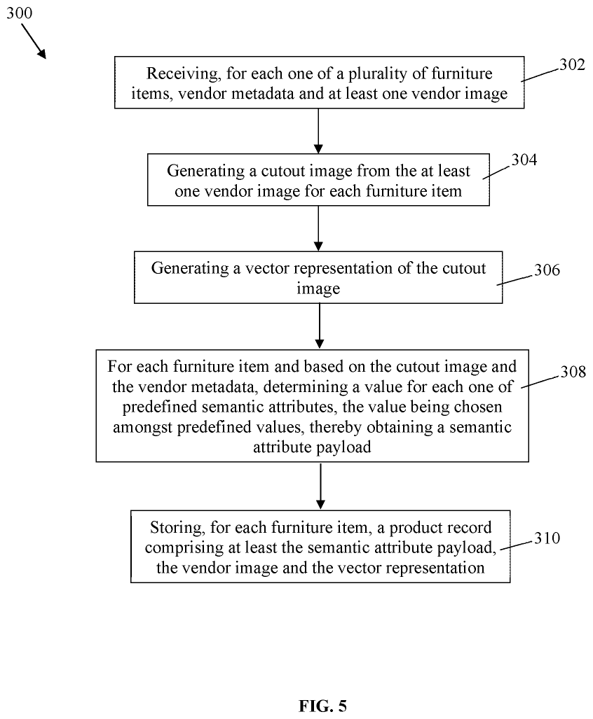

FIG. 5 illustrates one embodiment of a method 300 for generating a database of furniture items. As described below, the database can be used for recommending furniture items to a user.

In one or more implementations, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device upon executing the computer-readable instructions, is configured to or operable to execute the method 300.

According to processing step 302, the processing device receives, for each one of a plurality of furniture items, vendor metadata and at least one image of the furniture item, hereinafter referred to as a vendor image of the furniture item.

In some embodiments, the vendor metadata comprises a product name and a product description. The vendor metadata may further comprise a product category to which the product belongs.

In some embodiments, the vendor metadata comprise at least one of:
Identification & Sourcing information such as manufacturer name, prices, a vendor SKU, an MSRP, product identifiers and/or the like;
Physical Specifications such as dimensions, color, materials, weight, texture and/or the like;
Documentation such as sustainability credentials, LEED/WELL certification information, compliance documents and/or the like; and
Operational information such as inventory status, warehousing assignment, shipping dimensions and/or the like;
In some embodiments, the plurality of furniture items all belong to a same type or category of items. For example, the furniture items may all be chairs, tables, beds, or the like.

In other embodiments, the plurality of furniture items are part of different furniture types or categories. For example, some of the furniture items may be beds, other furniture items may be tables, etc. In this case, the vendor metadata associated with each furniture item may be indicative of the type or category to which the furniture item belongs. Alternatively, the type or category to which a furniture item belongs may be determined at a later stage.

In embodiments in which the vendor metadata are indicative of a product category or type to which the furniture item belongs, a normalized category may further be assigned to each furniture item since different vendors may use different names for a same category. For example, different vendors may use “lounge chair,” “accent seat,” “occasional seating” or the like to describe a same category of seats. In this case, a normalized category such as “seat category no. 1” may be assigned to any chairs categorized as “lounge chair,” “accent seat,” or “occasional seating” by a vendor.

The assignment of a category or type to a furniture item may be performed at step 308 described below.

In some embodiments, a vendor image shows the furniture item within a background such as within a lifestyle setting with background elements, props, and decorative objects not belonging to the furniture item itself.

According to processing step 304, the processing device generates a cutout image of the furniture item based on the image(s) received at step 302 for each furniture item. In some embodiments, the cutout image is generated further based on the category or type of furniture items to which the furniture item belongs. The cutout image comprises a representation of the furniture item only isolated from any background present in the image(s) received at step 302. It will be understood that any adequate method for generating a cutout image may be used.

In some embodiments, step 304 is performed into two sub-steps, i.e., a first sub-step consisting in localizing the furniture item whin the vendor image, e.g., identifying the pixels of the vendor image that represent the furniture item, and a second sub-step consisting in segmenting the vendor image to obtain the cutout image of the furniture item. In some embodiments, the output of the first sub-step is a bounding box surrounding the furniture item or the bounding box superimposed on the vendor image. The inputs of the second sub-step comprise the vendor image and the bounding box and its output is the cutout image.

In some embodiments, the localization of the furniture item within a vendor image is performed by the processing device using DINO (Self-DIstillation with NO labels), a self-supervised vision transformer that identifies and produces bounding box proposals for objects within an image without requiring task-specific training. In some embodiments, DINO may be well-suited to this task when vendor images contain furniture times in complex lifestyle environments with multiple objects.

In other embodiments, the localization of the furniture item within a vendor image is performed by at least one of the following methods:
YOLO (You Only Look Once) or a variant thereof, which is a real-time object detection model producing bounding box predictions for known object categories;
DETR (Detection Transformer) or any adequate transformer-based object detection model;
Grounding DINO, which extends DINO with text-guided localization enabling category-specific detection using the product name or category as a text prompt; and
OWL-ViT (Open-Vocabulary Object Detection with Vision Transformers), or any adequate methods that performs open-vocabulary object detection from text descriptions.

In some embodiments, the segmentation of the vendor image consists in generating a segmentation mask of the localized furniture item based on the identification previously performed and applying the mask to the vendor image to extract the cutout image from the vendor image. It will be understood that any adequate segmentation method may be used.

In some embodiments, the segmentation of the vendor image is performed using SAM2 (Segment Anything Model 2) based on the generated bounding box identifying the location of the furniture item within the vendor image to obtain a pixel-level segmentation mask of the localized furniture item.

In other embodiments, the segmentation of the vendor image is performed using one of the following methods:
SAM (Segment Anything Model);
Mask R-CNN or any adequate region-based convolutional neural network for instance segmentation;
SegFormer or any adequate transformer-based semantic segmentation model; and
OneFormer or any adequate universal image segmentation model.

According to processing step 306, the processing device generates a vector representation of the cutout image for each furniture item. It will be understood that the above-described method for generating a vector representation of a reference image can be used.

In some embodiments, the vector representation corresponds to a fixed-dimension numerical vector representation of the cutout image, encoding its visual features in a shared image-text embedding space.

In some embodiments, the vector representation of the cutout image is generated using CLIP (Contrastive Language-Image Pre-Training), which encodes the cutout image as a fixed-dimension vector. The same CLIP model instance is used consistently across all product ingestion and at query time (Step 2 of Method 2), ensuring that all product CLIP vectors and any inspiration image CLIP vectors produced at query time exist in the same vector space and are directly comparable by cosine similarity. The CLIP model used is not fine-tuned for this task; it is used as a general-purpose visual encoder.

According to processing step 308, the processing device determines, for each furniture item, a value for each one of predefined semantic attributes based on the cutout image and the vendor metadata to obtain a semantic attribute payload for each furniture item. The processing device determines, for each sematic attribute, the value amongst a predefined list of permitted values.

In some embodiments, the attributes comprise at least some of the following elements: color (primary, secondary, accent; temperature, saturation, tone, coverage), material (primary, secondary, tertiary; warmth, texture, sheen, finish, coverage), form (silhouette, shape, visual weight, scale, leg type, ornateness scale, placement, dominant line, edge profile, profile), pattern (scale, type, repeat), mood (curated tags), style (primary, secondary, era), light interaction, technical properties (maintenance, usage intensity, acoustics, comfort, assembly, waterproofing, UV/stain resistance, adjustability), sustainability (certifications, recycled content, country of origin), and seasonality

In some embodiments, step 308 is performed using a Large Mutilmodal Model (LMM) executed by the server 220 or another server (not shown). In this case, for each furniture, the processing device generates a prompt instructing the LMM to determine the semantic attribute values and transmits the vendor metadata and the cutout image to the LMM along with the prompt. It will be understood that the prompt is indicative of the permitted values for each semantic attribute. The LMM then determines the value for each semantic attribute and transmit the determined values to the processing device.

It will be understood that any adequate LMM capable of processing both image and text inputs, such as Gemini™ may be used.

In some embodiments, the cutout image and the vendor metadata are passed together to the LMM. The LMM is instructed via a system prompt to analyze the cutout image and the vendor metadata and produce a structured attribute payload by selecting values exclusively from fixed, curated sets of permitted values defined for each semantic attribute. The system prompt specifies the full attribute schema and the complete set of permitted values for each attribute field. The LMM is not permitted to generate free-form or open-ended attribute values. This constraint ensures consistent, filterable payloads across all products regardless of vendor. The use of the cutout image ensures that the LMM's visual analysis is focused on the target furniture item itself, without interference from background objects, props, or environmental elements present in the original lifestyle image.

In the following, there is provided an exemplary prompt for instructing the LMM:
You are an expert furniture and interior design analyst. You will be provided with:
1. A cutout image of a furniture product (the product isolated from its background).
2. Vendor metadata for the product (name, description, dimensions, materials, price).

Your task is to analyze both inputs and produce a structured attribute payload for the product.

RULES:
For every attribute, you MUST select a value exclusively from the permitted enum values listed in the schema below. You may NOT generate free-form or open-ended values.
Base visual attributes (color, material, form, pattern, mood, style, light interaction) on the cutout image. The vendor metadata is a secondary hint only—always trust the visual appearance over vendor descriptions where they conflict.
Base commercial and technical attributes (dimensions, weight, certifications, assembly) on the vendor metadata.
Coverage percentages for color and material must sum to 100 across primary+secondary+accent/tertiary fields.
If an attribute cannot be determined from either input, set it to null.
Return ONLY a valid JSON object. No preamble, no explanation, no markdown.

SCHEMA:
{“primaryColorName”: one of [red|orange|yellow|green|blue|purple|pink|brown|beige|cream|white|grey|black|navy|teal|olive|terracotta|rust|gold|silver|bronze|amber|ivory|charcoal|taupe|sage|cognac|forest_green],
“primaryColorTemperature”: one of [warm|cool|neutral],
“primaryColorSaturation”: one of [muted|moderate|vivid],
“primaryColorTone”: one of [light|mid|dark],
“primaryColorCoveragePercentage”: integer 0-100,
. . . [full schema continues for all attribute groups] . . .
“stylePrimary”: one of [minimalist|scandinavian|japandi|modern|contemporary|transitional|traditional|industrial|mid_century_modern|art_deco|. . . ],
“mood”: array of 2-4 values from [serene|cozy|airy|grounded|dramatic|playful|romantic|energising|fresh|meditative|rustic|tropical|sophisticated|opulent|edgy|whimsical|austere|inviting|vibrant|nostalgic|cinematic|organic]

According to processing step 310, the processing device stores the determined or received semantic attribute payload, i.e., the semantic attribute values, for each furniture item in a database such as database 230. Further, the processing device stores the vendor metadata, the vendor image(s) and the vector representation generated at step 306 in the database along with the semantic attribute values. As a result, in the database, each furniture item is associated with a respective semantic attribute payload, respective vendor metadata, at least one respective vendor image and a respective vector representation, which is referred to as a product record hereinafter.

In some embodiments, the cutout image is further stored in the database and associated with its respective furniture item. In this case, each product record further comprises the cutout image generated from the vendor image(s).

In some embodiments in which the furniture items belong to different categories or types of furniture items, the type of the furniture item is further stored in the database and associated with the furniture item. In this case, each product record further comprises category or type of furniture items. In some embodiment, the category stored in the database corresponds to the normalized category described above which is determined by the LMM.

In some embodiments, step 306 is omitted and no vector representation of the furniture items is generated. In this case, each product record comprises no vector representation.

In some embodiments, step 304 is omitted and no cutout image is generated. In this case, step 306 is performed based on the vendor image(s) instead of the cutout image, i.e., the vector representation generated at step 306 is a vector representation of the vendor image. In this case, each product record comprises no cutout image.

In some embodiments in which the furniture items belong to different categories or types of furniture items and in which the vendor metadata are not indicative of the type or category for the furniture item, the method further comprises a step of determining the type or category of the furniture item such as a normalized type or category based on the vendor metadata and the cutout image (and/or the vendor image(s)).

In some embodiments in which the furniture items belong to different categories or types of furniture items and in which the vendor metadata are indicative of the type of type for the furniture item, the method further comprises a step of determining a normalized type or category for the furniture item based on the vendor metadata and the cutout image (and/or the vendor image(s)).

For example, the type or normalized type of the furniture item may be determined using any adequate object recognition, detection or classification method and the vendor image and/or the cutout image. For example, Convolutional Neural Networks (CNN), Region-based Convolutional Neural Networks (R-CNN) and its variants such as Fast R-CNN or Faster R-CNN, You Only Look Once (YOLO), Single Shot Multibox Detector (SSD), RetinaNet, Mask R-CNN, Vision Transformers (ViTs), Residual Networks (ResNets), or the like may be used for recognizing/identifying the type of the furniture item.

In another example, the LMM may be instructed to further identify the type or normalized type of furniture item and transmits it to the processing device.

In some embodiments, each product or furniture item stored in the database is enriched at ingestion with a structured semantic attribute payload comprising design-relevant attributes, each drawn from a fixed, curated vocabulary. This enables precise, filterable retrieval across dimensions that visual similarity alone cannot capture, such as ornateness level, dominant line, material warmth, light interaction, mood, design era and/or the like. This further allows enforcement of explicit design rules, such as “no leather,” “warm wood tones only,” or “stain-resistant fabric”, as hard constraints on retrieval.

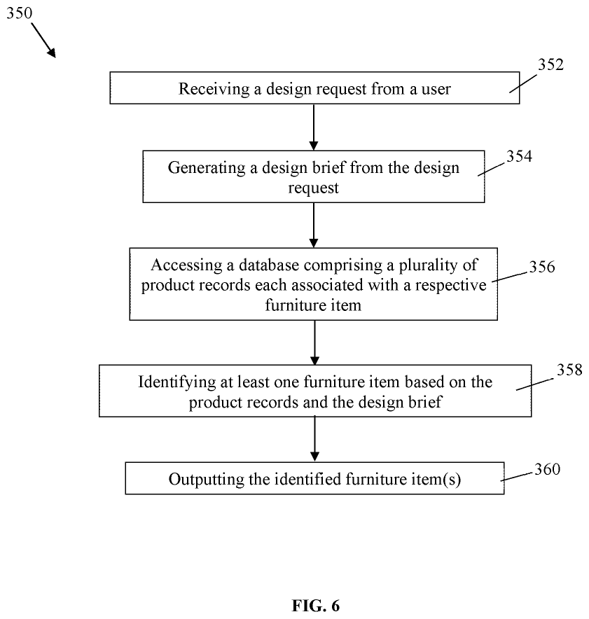

FIG. 6 illustrates one embodiment of a method 350 for recommending a furniture item to a user.

In one or more implementations, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device upon executing the computer-readable instructions, is configured to or operable to execute the method 350.

According to processing step 352, the processing device receives a design request from a user.

A design request corresponds to a natural language input identifying at least a desired furniture item such as “a chair.” The design request may further describe characteristics for the desired item, the room type associated with the desired item, style preferences, a budget, spatial constraints, design rules and/or the like.

In some embodiments, the user may use any computer device provided with a user interface, such as computer device 210, to input his design request and transit the design request to the processing device.

According to processing step 354, the processing device generates a design brief based on the design request. The design brief describes at least one desired furniture item or item category to be searched.

A design brief is a foundational project management document that outlines the scope, requirements, expectations, and constraints of a design project. The generated design brief captures the design intent for the design request, including room type, style direction, color palette, material preferences, mood, required furniture categories, and/or spatial and budget constraints. The generated design brief is analogous to a brief a human interior designer would produce before sourcing furniture.

In some embodiments, the generated design brief is indicative of:
Project Overview: Statement of the project goals, room type, architectural style and/or the like;
Client Profile: Details about the occupants, daily routines, lifestyle, and specific spatial needs, and/or the like;
Design Scope: Specific rooms, areas, or furniture items categories included in the decoration, and/or the like;
Aesthetic Preferences: Desired visual style, colour palettes, materials, textures, atmospheres/moods and/or the like;
Functional Requirements: Spatial layout needs, storage demands, lighting preferences, acoustic priorities and/or the like; and/or
Budget Allocation: financial limits per item category, total financial limits and/or the like.

In some embodiments, the design brief is generated an artificial intelligence (AI) model or agent such as a Large Language Model (LLM) or an LMM that is executed on the server 220 or another server. In this case, the AI agent is instructed to generate the design brief based on the design request and may interact with the user via the processing device to improve or clarify the design request. The processing device receives the design request from the user, generates a prompt which incorporates the initial design request and transmits the prompt to the AI agent. If the AI agent sends questions to the processing device, the processing device transmits the questions to the user and upon reception of the answers from the user, transmits the answers to the AI agent. Several iterations may occur until the AI agent no longer ask questions and outputs the design brief. In some embodiments, the design brief may be presented to the user for validation.

In some embodiments, the AI agent asks questions to the user until enough information to create a design brief is received. For example, if the initial design request inputted by the user comprises: “a chair,” the AI agent may ask the user the following information: for which room type, which color, which material, which price range, etc. In some embodiments, the AI agent conducts a natural, multi-turn dialogue with the user to extract design intent, preferences, constraints, and design rules, exactly as a professional interior designer would during a client intake.

In some embodiments. the AI agent is configured via a system prompt to behave as an expert interior designer. The AI agent receives the user's initial design request through a multi-turn conversational interface and engages in dialogue to clarify design intent, constraints, and preferences as needed. The AI agent autonomously determines what information it requires before proceeding and asks targeted clarifying questions, such as asking about room size, budget, existing furniture to keep, or preferred styles, thereby mirroring the intake process a human designer would conduct with a client/user.

In some embodiments, the system prompt explicitly instructs the AI agent to identify and record design rules from the client conversation. Design rules are constraints that govern what is acceptable in the final design. The design rules may be identified autonomously by the AI agent from the user's stated preferences during the intake conversation and may be incorporated as binding constraints into the design brief. Design rules may also comprise explicit constraints stated or implied by the user that govern what is acceptable in the final design.

Examples of design rules the agent may identify and record may comprise:
“No leather materials”—identified when a user states a preference or allergy.
“All metal finishes must match throughout”—identified from a user's comment about consistency.
“Warm wood tones only”—identified from a user's stated color preference.
“All seating must be pet-friendly or stain-resistant fabric”—identified when user mentions pets.
“No glass surfaces”—identified when user mentions children or safety concerns.
“Maximum item height 80 cm”—identified from spatial constraints stated by the user.

In the following there is provide an exemplary prompt to be transmitted to an LLM along with the initial design request received from the user:

You are Ludwig, an expert interior and exterior designer working for a premier furniture and design platform. You have deep expertise in design styles, color theory, material pairing, spatial composition, and furniture selection.

YOUR ROLE:

You act as a professional designer conducting a design consultation with a client. Your goal is to deeply understand the client's vision and translate it into a precise, coherent design direction that can be executed through product selection.

HOW YOU WORK:
1. Conduct a natural, conversational intake with the client to understand:
   The room or space being designed (type, size, existing elements to keep)
   Their design style preferences and aesthetic references
   Budget range
      Any non-negotiables or design constraints (e.g. no leather, pet-friendly fabrics, specific color restrictions)
2. From this conversation, you autonomously formulate an internal design brief
   covering: room type, primary and secondary design style, color palette, material direction, mood, required furniture categories, and all design rules identified from the client's stated preferences.
3. Design rules are explicit constraints that govern what is acceptable in the final design. You identify these from the client's stated preferences and record them as binding constraints. Examples: “no leather materials”, “all metal finishes must match”, “warm wood tones only”, “all seating must be stain-resistant fabric”.
4. Once you have a clear design brief, you instruct the sourcing agent on exactly what products are needed, what design characteristics they must have, and what design rules must be respected.
5. When products are returned, you generate a precise visual prompt for the visualization agent describing the exact layout, arrangement, and atmosphere you want rendered.

You are creative, decisive, and precise. You do not ask for more information than you need. You make autonomous design decisions within the constraints provided.

According to processing step 356, the processing device accesses a database of available furniture items such as database 230. The database has stored thereon a product record for each one of the available furniture items. For example, the database may have been created using the method 300.

For each furniture item, a product record comprises at least a semantic attribute payload (i.e., semantic attribute values as described above). A product record may further comprise vendor metadata and/or at least one vendor image. In embodiments in which the furniture items belong to different categories or types, a product record further comprises the category to which the furniture item belongs.

According to processing step 358, the processing device identifies at least one candidate furniture item amongst the plurality of furniture items stored in the database based on the product records and the design brief. The processing device compares the information contained in the design brief to the information contained in the product records to identify the candidate furniture item(s) that correspond(s) to the furniture item described in the design brief.

In embodiments in which the furniture items belong to different categories or types, the processing device may identify at least one furniture item per category.

In some embodiments, the candidate furniture item is identified by an AI query agent such as an LLM or an LMM that is executed on the server 220 or another server. In this case, step 356 consists in providing the query agent with an access to the database and the query agent is instructed to identify the candidate furniture item amongst the furniture items stored in the database based on the design brief. The processing device generates a prompt which incorporates the design brief and transmits the prompt to the query agent which returns the candidate furniture item(s).

In some embodiments, the system prompt instructs the query agent on: how to interpret the design brief; how to construct queries comprising attribute payload filters; how to evaluate results returned by the database against the design brief; and how to iteratively refine queries when results are insufficient.

In some embodiments, the query agent constructs a query using attribute payload filters derived from the design brief and executes the query against the database. Result retrieval is based on the structured semantic attribute payloads contained in the database. In some embodiments, the query agent iteratively adjusts the filters and limits as needed until results are satisfactory. In some embodiments, the query agent autonomously determines the number of identified candidate items based on the complexity and specificity of the design brief.

In some embodiments, the query agent autonomously tailors its query strategy to the complexity and specificity of each design request, selecting the most appropriate underlying language model based on a complexity grading mechanism, and iteratively self-correcting its queries until results are satisfactory.

In embodiments in which the furniture items stored in the database belong to a plurality of categories and the design brief is indicative of furniture items belonging to different categories, the query agent generates a query per category of items indicated in the design brief. The query agent then identifies at least one candidate furniture item per category indicated in the design brief.

In some embodiments, more than one LLM or LMM are used for identifying the candidate items(s). The query agent may select the LLM or LMM to be used based a complexity grading mechanism to select the most appropriate model for each query request. For example, a complexity score may be assigned to each query and the LLM or LMM may be selected based on the complexity score. The lowest score may be assigned to the simplest queries (e.g., a single-category query with clear, simple constraints) and the highest complexity score may be assigned to the most complex queries (e.g., multi-category queries with nuanced design rules, conflicting constraints, or highly specific attribute combinations). A routing mechanism may evaluate the complexity score and selects the appropriate model accordingly:

In some embodiments, the complexity score may vary between 1 and 5. For any query having a complexity score or 1 or 2, Gemini Flash Lite or Gemini Flash may be used to identify the candidate furniture item(s). For queries having a complexity score of 3, such as for moderate complexity queries requiring more nuanced instructions, Claude Haiku may be used. For queries having a complexity score of 4, such as for complex multi-constraint queries, Claude Sonnet may be used. For queries having a complexity score of 5, i.e., the highest complexity queries, Claude Opus may be used. It will be understood that the selection of the particular model to be used is performed before a query be executed.

In some embodiments, the query agent evaluates returned results against the design brief instructions it received, checking: whether the number of returned candidates per category meets a minimum threshold it deems sufficient for meaningful selection; whether the returned candidates'attribute values (e.g., style, color, material, mood) are consistent with the design brief constraints; and/or whether any design rules have been violated by the returned candidates (e.g., leather products returned when “no leather” was a stated rule). In some embodiments, when it identifies a shortfall in any of these dimensions, the query autonomously adjusts the query parameters (such as relaxing score thresholds, broadening attribute filters, increasing result limits, etc.) and generates a new query.

In the following there is provide an exemplary prompt to be transmitted to a query agent along with the design brief to instruct the agent to identify candidate furniture items:

You are a specialized product sourcing agent, an interior design platform. You have direct access to the product database via the vector database API.

YOUR ROLE:

You receive instructions from the Design Chat Agent specifying what furniture products are needed for a design project. Your job is to query the database and return the best candidate products per required category.

HOW YOU WORK:
1. Parse the Design Chat Agent's instructions to identify:
   Required furniture categories (e.g., sofa, dining table, accent chair, rug, lamp)
   Required design characteristics per category (style, color, material, mood, etc.)
   Any design rules that must be respected (e.g., no leather, warm tones only)
   Whether an inspiration image vector has been provided
2. For each required category, construct a database query that combines:
Attribute payload filters matching the required design characteristics (e.g., stylePrimary=“mid_century_modern”, primaryColorTemperature=“warm”)
   If an inspiration image CLIP vector is provided: include it as the primary search vector for image similarity search
   If no inspiration image is provided: use attribute filters only
3. Execute the query and evaluate the results:
   Are there enough candidates per category? (minimum threshold varies by category)
   Do the results genuinely reflect the design brief and design rules?
   If not: adjust score thresholds, relax or tighten attribute filters, or increase the result limit, and re-query. Repeat until satisfied.
4. Return the full candidate product sets per category to the Design Chat Agent.

You are precise, systematic, and autonomous. You do not ask for clarification—you make judgment calls and iterate until the results meet the brief.

Referring back to FIG. 6 and according to processing step 360, the processing device outputs the identified candidate furniture item(s). For example, an identification or indication of the candidate item(s) may be stored in memory. In another example, an indication of the identified candidate item(s) (such information about the candidate item(s) retrieved from the database) may be provided for display to the user.

In some embodiments, the method 350 further comprises the steps of generating a visual representation of the identified item within a space such as within a room and providing the visual representation for display to the user. For example, a visual representation of a room may be generated and a visual representation of the identified candidate item (which may be the above-mentioned vendor image or cutout image) is inserted in the visual representation of the room. In some embodiments, step 352 further comprises receiving an image of space such as a room from the user. In this case, this image is used for generating the visual representation by inserting the visual representation of the identified item within the received image. Further detail about the generation of the visual representation is provided below.

In some embodiments, the method 350 allows for identifying and recommending furniture items based on natural language input alone.

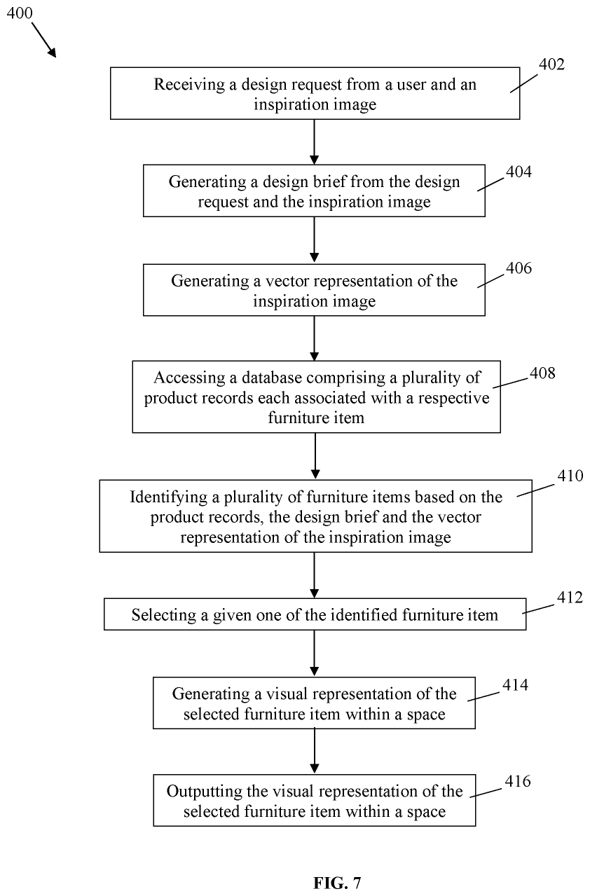

FIG. 7 illustrates another embodiment of a method 400 for recommending a furniture item to a user.

In one or more implementations, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device upon executing the computer-readable instructions, is configured to or operable to execute the method 400.

According to processing step 402, the processing device receives a design request from a user and an inspiration or reference image. The design request is similar to the one described with respect to method 350 and the inspiration image is similar to the reference image described above. The inspiration image may depict a desired design a desired aesthetic, a desired mood, a desired style and/or the like.

In some embodiments, step 402 further comprises receiving an image of a space in which the desired furniture item is to be placed (hereinafter referred to as the space image) from the user. For example, the space image may depict the actual room or space being designed.

According to processing step 404, the processing device generates a design brief based on the design request and the inspiration image. The design brief is similar to the one described at step 354.

In some embodiments, the design brief is generated by an LMM based on the design request and the inspiration image in a manner similar to the one described at step 354. In embodiments in which a space image is received at step 402, the design brief may be generated further based on the space image.

According to processing step 406, the processing device generates a vector representation of the inspiration image in a manner similar to the one presented above with respect to step 158 or 306.

According to processing step 408, the processing device accesses a database of available furniture items such as database 230. The database has stored thereon a product record for each one of the available furniture items. For example, the database may have been created using the method 300.

For each furniture item, a product record comprises at least a semantic attribute payload (i.e., semantic attribute values as described above) and a vector representation of a cutout image or a vendor image. A product record may further comprise vendor metadata and/or at least one vendor image. In embodiments in which the furniture items belong to different categories or types, a product record further comprises the category to which the furniture item belongs.

According to processing step 410, the processing device identifies a plurality of candidate furniture items amongst the plurality of furniture items stored in the database based on the product records, the design brief and the vector representation of the inspiration image.

In embodiments in which the design brief indicates that items from different categories are desired, the processing device identifies a set of candidate item for each category.

In some embodiments, an LMM query agent is used for identifying the candidate items in a manner similar to that described above with respect step 358. For each required furniture category, the query agent constructs a query that combines: the vector representation of the inspiration image and attribute payload filters derived from the design brief and executes the query against the database. Vector similarity is used for identifying the items of which the associated vector representations are the closest to the vector representation of the inspiration image and the attribute payload filters derived from the design brief are used to retrieve the candidate items based on their associated attribute payload.

In embodiments in which the furniture items stored in the database belong to a plurality of categories and the design brief is indicative of furniture items belonging to different categories, the query agent generates a query per category of items indicated in the design brief. The query agent then identifies a plurality of candidate furniture items per category indicated in the design brief.

In some embodiments, the design brief acts as a constraint layer: products that violate design rules (e.g., a leather product when “no leather” was specified) are excluded from consideration regardless of the similarity score obtained from the comparison of their vector representation stored in the database and the vector representation of the inspiration image.

According to processing step 412, the processing device identifies a single candidate item amongst the plurality of candidate items identified at step 410 based on the vector representation of the inspiration image.

In some embodiments, the processing assigns a similarity score to the candidate items identified at step 410 and identifies the single candidate item as being the item having the highest score. The similarity score reflects how closely an item's visual character matches the aesthetic of the inspiration image and is indicative of the similarity between the vector representation of the inspiration image and the vector representation of the cutout image associated with a candidate item. For example, cosine similarity may be used to assign a similarity score. In another example, the K-nearest neighbors (KNN) method described above may be used.

It will be understood that when the plurality of candidate items identified at step 410 belong to different item categories, a single item per category is identified at step 408.

According to processing step 414, the processing device generates a visual representation of the single identified furniture item identified at step 412 within a space such as within the room. In some embodiments, the visual representation is generated based on the semantic attribute payload and the vendor image associated with the furniture item identified at step 412 and the inspiration image. In some embodiments, the visual representation is generated further based on the space image if received at step 402.

In some embodiments in which several furniture items belonging to different categories have been identified at step 412, the visual representation generated at step 414 represents the identified items within the same space.

In some embodiments in which a space image is received at step 402, the visual representation generated at step 414 corresponds to the space image in which a visual representation of the furniture item(s) identified at step 412 is inserted.

In some embodiments, the visual representation of the identified furniture item(s) within a space is generated using a LMM (hereinafter referred to as the visualization LMM) such as Gemini^{TM}. In this case, a prompt instructing the visualization LMM how to generate the visual representation (hereinafter referred to as the visual prompt) is first generated and then transmitted to the visualization LMM which generates the visual representation and returns the generated visual representation. For example, the visual prompt may indicate the room type, the arrangement of items, the layout, the viewing angle, the desired atmosphere, and/or the like.

In some embodiments, the visual prompt is generated by the processing device. In other embodiments, the visual prompt is generated by an AI agent such as an LLM or an LMM based on the semantic attribute payload and the vendor image associated with the furniture item(s) identified at step 412. In this case, the processing device instructs the AI agent to generate a visual prompt based on the semantic attribute payload and the vendor image, receives the visual prompt from the AI agent, transmits the visual prompt to the visualization LMM and receives the generates visual representation from the visualization LMM.

In some embodiment, the same AI agent that generated the design brief is also used to generate the visual prompt for the visualization LMM. The use of the agent same ensures that consistency between the prompt and the design brief is achieved, thereby ensuring the visual representation reflects the design intent expressed in the design brief.

In some embodiments in which no space image is received at step 402, the visualization LMM receives the prompt and the vendor image (and/or the cutout image) for the identified furniture item(s). The visualization LMM generates a scene from scratch consistent with the instructions contained in the visual prompt. The visualization LMM inserts a visual representation of the identified item(s) within the scene. The visual representation of the identified item(s) may be generated based on the vendor image and/or the cutout image. The visualization LMM outputs a rendered image of the designed space, i.e., a rendered image of the scene in which a visual representation of the identified item(s) is inserted.

In some embodiments in which a space image is received at step 402, the visualization LMM receives the prompt and the vendor image (and/or the cutout image) for the identified furniture item(s) in addition to the space image. The visualization LMM renders the identified furniture item(s) into the actual space depicted in the space image, thereby producing a photorealistic or illustrative visualization of how the identified item(s) would look in the space depicted in the space image.

In some embodiments, the visualization LMM ensures spatial coherence within the generated visual representation. The visualization LMM renders the identified item(s) at a correct relative scale, in plausible spatial position, with consistent lighting and perspective which may be achieved by grounding the render in the geometry and proportions of the space depicted in the space image.

In the following, there is presented an exemplary prompt for instruction the visualization LMM to generate the visual representation:

Render a warm, mid-century modern living room scene in a photorealistic style.

LAYOUT:
Place the three-seat walnut-frame sofa as the anchor piece, facing slightly toward the viewer at a ¾ angle, positioned against a soft white wall.
Position the oval marble coffee table centered in front of the sofa, approximately 45 cm clearance.
Place the accent armchair to the left of the sofa at a 45-degree angle, creating a conversational grouping.
Position the floor lamp behind and to the right of the sofa, switched on, casting warm ambient light.
Layer the wool area rug beneath all seating, extending approximately 30 cm beyond the front legs of the sofa.

ATMOSPHERE:
Warm afternoon light entering from the left.
Palette: warm walnut tones, ivory upholstery, soft terracotta accents.
Mood: sophisticated, inviting, grounded.
No clutter. Minimal styling—one or two books on the coffee table at most.

Viewing angle: eye-level, slightly elevated. Wide enough to show the full grouping with some wall and floor context.

Referring back to FIG. 7 and according to processing step 416, the processing device outputs the visual representation of the identified item(s) within the space. For example, the visual representation may be stored in memory. In another example, the visual representation may be provided for display to the user. In this case, the processing device transmits the visual representation to the user device which displays the visual representation on a display.

While the above description refers to interior design, the person skilled in the art will understand that the above-described technology also applies to exterior design with garden furniture items.

Modifications and improvements to the above-described implementations of the present technology may become apparent to those skilled in the art. The foregoing description is intended to be exemplary rather than limiting.

1. A system for recommending a furniture item to a user, the system comprising:
a processor; and
a non-transitory readable storage medium operatively connected to the processor, the non-transitory readable storage medium comprising computer-readable instructions stored thereon,
the processor, upon execution of the instructions, being configured for:
receiving a design request indicative of at least one desired furniture item from a user device;
generating a design brief based on the design request;
accessing a database comprising product records each associated with a respective furniture item, each one of the product records comprising vendor metadata about the respective furniture item and semantic attribute values associated with the respective furniture item;
identifying at least one given furniture item based on the product records and the design brief; and
outputting an indication of the at least one given furniture item.

2. The system of claim 1, wherein said generating a design brief comprises:
generating a prompt instructing an artificial intelligence model to create the design brief;
transmitting the prompt and the design request to the artificial intelligence model; and
receiving the design brief from the artificial intelligence model.

3. The system of claim 2, wherein the processor is further configured for allowing an interaction between the artificial intelligence model and the user via the user device to construct the design brief.

4. The system of claim 2, wherein the processor is further configured for receiving an inspiration image and transmitting the inspiration image to the artificial intelligence model along with the design request and the prompt, the design brief being generated further based on the inspiration image.

5. The system of claim 1, wherein said identifying the at least one given furniture item comprises:
generating a prompt instructing an artificial intelligence model to construct a query comprising semantic attribute filters;
transmitting the prompt and the design brief to the artificial intelligence model;
providing the artificial intelligence model with an access to the database; and
receiving the at least one given furniture item from the artificial intelligence model, the artificial intelligence model identifying the at least one given furniture item based on the prompt, the design brief and the product records stored in the database.

6. The system of claim 5, wherein each one of the product record further comprises a reference vector representation for the respective furniture item, the method further comprising:
receiving an inspiration image;
generating a vector representation of the inspiration image; and
transmitting the vector representation of the inspiration image to the artificial intelligence model along with prompt and the design brief, the at least one given furniture item being identified further based on the vector representation of the inspiration image.

7. The system of claim 6, wherein said receiving the at least one given furniture item from the artificial intelligence model comprises receiving a plurality of given furniture items, the method further comprises selecting a given one of plurality of given furniture items based on the vector representation of the inspiration image.

8. The system of claim 1, wherein said outputting the indication of the at least one given furniture item comprises:
generating a visual representation of the at least one given furniture item within a space; and
outputting the visual representation.

9. The system of claim 8, wherein the processor is further configured for receiving a space image, said generating the visual representation being performed based on the space image.

10. A system for creating a database of furniture items, the system comprising:
a processor; and
a non-transitory readable storage medium operatively connected to the processor, the non-transitory readable storage medium comprising computer-readable instructions stored thereon,
the processor, upon execution of the instructions, being configured for:
receiving, for each one of a plurality of furniture items, vendor metadata and at least one vendor image;
generating a vector representation of the at least one vendor image for each one of a plurality of furniture items;
for each one of a plurality of furniture items, determining a value for each one of predefined semantic attributes based at least on the vendor metadata and the at least one vendor image, the value being selected amongst predefined possible values; and
storing, for each one of a plurality of furniture items, the value of each one of predefined semantic attributes and the vector representation of the at least one vendor image.

11. The system of claim 10, wherein the processor is further configured for generating a cutout image from the at least one vendor image, said generating the vector representation of the at least one vendor image comprising generating a vector representation of the cutout image and said storing the vector representation of the at least one vendor image comprising storing the vector representation of the cutout image.

12. A method for recommending a furniture item to a user, the method being executed by a processing device, the method comprising:
receiving a design request indicative of at least one desired furniture item from a user device;
generating a design brief based on the design request;
accessing a database comprising product records each associated with a respective furniture item, each one of the product records comprising vendor metadata about the respective furniture item and semantic attribute values associated with the respective furniture item;
identifying at least one given furniture item based on the product records and the design brief; and
outputting an indication of the at least one given furniture item.

13. The method of claim 12, wherein said generating a design brief comprises:
generating a prompt instructing an artificial intelligence model to create the design brief;
transmitting the prompt and the design request to the artificial intelligence model; and
receiving the design brief from the artificial intelligence model.

14. The method of claim 13, further comprising allowing an interaction between the artificial intelligence model and the user via the user device to construct the design brief.

15. The method of claim 13, further comprising receiving an inspiration image and transmitting the inspiration image to the artificial intelligence model along with the design request and the prompt, the design brief being generated further based on the inspiration image.

16. The method of claim 12, wherein said identifying the at least one given furniture item comprises:
generating a prompt instructing an artificial intelligence model to construct a query comprising semantic attribute filters;
transmitting the prompt and the design brief to the artificial intelligence model;
providing the artificial intelligence model with an access to the database; and
receiving the at least one given furniture item from the artificial intelligence model, the artificial intelligence model identifying the at least one given furniture item based on the prompt, the design brief and the product records stored in the database.

17. The method of claim 16, wherein each one of the product record further comprises a reference vector representation for the respective furniture item, the method further comprising:
receiving an inspiration image;
generating a vector representation of the inspiration image; and
transmitting the vector representation of the inspiration image to the artificial intelligence model along with prompt and the design brief, the at least one given furniture item being identified further based on the vector representation of the inspiration image.

18. The method of claim 17, wherein said receiving the at least one given furniture item from the artificial intelligence model comprises receiving a plurality of given furniture items, the method further comprises selecting a given one of plurality of given furniture items based on the vector representation of the inspiration image.

19. The method of claim 12, wherein said outputting the indication of the at least one given furniture item comprises:
generating a visual representation of the at least one given furniture item within a space; and
outputting the visual representation.

20. The method of claim 19, further comprising receiving a space image, said generating the visual representation being performed based on the space image.

21. A method for creating a database of furniture items, the method being executed by a processing device, the method comprising:
receiving, for each one of a plurality of furniture items, vendor metadata and at least one vendor image;
generating a vector representation of the at least one vendor image for each one of a plurality of furniture items;
for each one of a plurality of furniture items, determining a value for each one of predefined semantic attributes based at least on the vendor metadata and the at least one vendor image, the value being selected amongst predefined possible values; and
storing, for each one of a plurality of furniture items, the value of each one of predefined semantic attributes and the vector representation of the at least one vendor image.

22. The method of claim 21, further comprising generating a cutout image from the at least one vendor image, said generating the vector representation of the at least one vendor image comprising generating a vector representation of the cutout image and said storing the vector representation of the at least one vendor image comprising storing the vector representation of the cutout image.
